(19) United States
(12) Patent Application Publication
(10) Pub. No.: US 2015/0149229 A1
(43) Pub. Date: May 28, 2015

(54) TRAVEL PLAN APPARATUS, METHOD AND STORAGE MEDIA

(71) Applicant: INSTITUTE FOR INFORMATION INDUSTRY, Taipei (TW)

(72) Inventors: Meng-Hsuan CHIA, Taipei City (TW); Wei-Syun LIN, Kaohsiung City (TW); I-Chou HUNG, Yilan County (TW); Chan-Chien YU, New Taipei City (TW)

(73) Assignee: INSTITUTE FOR INFORMATION INDUSTRY, Taipei (TW)

(21) Appl. No.: 14/103,858

(22) Filed: Dec. 12, 2013

(30) Foreign Application Priority Data
Nov. 28, 2013 (TW) 102143449

(51) Int. Cl. G06Q 10/10; G06Q 50/14

(52) U.S. Cl. CPC G06Q 10/1093; G06Q 50/14
USPC 705/7.18

(57) ABSTRACT

A travel plan apparatus, method, and a storage media are provided. The travel plan method includes: providing tourist attractions, travel days and travel configurations; determining at least one candidate hotel according to hotel configuration of the travel configurations; determining groups according to at least one candidate hotel and the travel days; distributing each one of the tourist attractions to a corresponsive group of the groups by using a relation-clustering method; when a quantity of first groups including at least one tourist attraction of the groups is larger than a quantity of the travel days, distributing tourist attractions of a second group including the tourist attractions with the shortest traveling time to other groups of the first groups by using the relation-clustering method.

### RELATED APPLICATIONS

This application claims priority to Taiwan Application Serial Number 102143449, filed Nov. 28, 2013, which is herein incorporated by reference.

### BACKGROUND

1. Field of Invention

The present invention relates to a travel plan method and a travel plan apparatus thereto. More particularly, the present invention relates to a travel plan method for selecting various hotels and a travel plan apparatus thereto.

2. Description of Related Art

There are several conventional methods for arranging a travel schedule. The first method is selecting several tourist spots by the user. The tourist spots are connected through the algorithm by the computer and the hotels around the tourist spots are selected by the user. The second method is selecting an original point and a destination point by the user. The tourist spots on a path between the original point and the destination point are recommended by the navigation system. The third method is configuring the same hotel in each of the travel days, and the tourist spots are searched around the configured hotel. The fourth method is selecting at least one of the tourist spots and at least one hotels provided from the Internet by the user.

However, the aforementioned conventional methods are inefficient. Since the user has to select the tourist spots and arrange the schedule by himself according to data of the tourist spots through the aforementioned conventional methods, the user may cost much time on arranging the travel schedule. Moreover, the user may spend much travel time on the traffic as a result that the travel time is shortened or the quantity of the tourist spots is reduced through the aforementioned conventional methods.

### SUMMARY

One aspect of the present invention is to provide a travel plan method. The travel plan method includes the following steps: providing tourist attractions, travel days, and travel configurations; determining at least one candidate hotel according to hotel configurations of the travel configurations; determining groups according to at least one candidate hotel and the travel days. Each of at least one candidate hotel includes the groups corresponding to the travel days; distributing each of the tourist attractions to a corresponding one of the groups by using a relation-clustering method; when the quantity of first groups of the groups including at least one of the tourist attractions is larger than the quantity of the travel days, distributing the tourist attractions of a second group of the first groups to other groups of the first groups, in which the second group including the tourist attractions with the shortest travel time.

Another aspect of the present invention is to provide a travel plan apparatus. The travel plan apparatus includes an input interface, a database, a hotel-selection module, a group-generation module, and a group-distribution module. The input interface is configured for receiving tourist attraction, travel days, and travel configurations. The database is configured for providing data corresponding to the tourist attractions and hotels. The hotel-selection module is configured for analyzing the data corresponding to the tourist attractions and hotels in the database according to hotel configurations of the travel configurations to determine at least one candidate hotel. The group-generation module is configured for determining groups according to at least one candidate hotel and the travel days. Each of at least one candidate hotel includes the groups corresponding to the travel days. The group-distribution module is configured for distributing each of tourist attractions to a corresponding one of the groups by using a relation-clustering method. When the quantity of first groups of the groups including at least one of tourist attractions is larger than the quantity of the travel days, the group-distribution module distributes the tourist attractions of a second group of the first groups to other groups of the first groups, in which the second group including the tourist attractions with the shortest travel time.

Other one aspect of the present invention is to provide a storage media for storing a travel plan program, wherein the travel plan program includes program codes to be loaded onto a computer system so that a travel plan method is executed by the computer system. The travel plan method includes the following steps: providing tourist attractions, travel days, and travel configurations; determining at least one candidate hotel according to hotel configurations of the travel configurations; determining groups according to at least one candidate hotel and the travel days. Each of at least one candidate hotel includes the groups corresponding to the travel days; distributing each of the tourist attractions to a corresponding one of the groups by using a relation-clustering method; when the quantity of first groups of the groups including at least one of the tourist attractions is larger than the quantity of the travel days, distributing the tourist attractions of a second group of the first groups to other groups of the first groups, in which the second group including the tourist attractions with the shortest travel time.

In summary, through the travel plan method, all tourist attractions of the travel schedule can be arranged automatically within the configured travel days, and the user do not have to stay in the same hotel in each of the travel days. In other words, the travel arrangement becomes more flexible and convenient, and it save more traffic time in the travel.

It is to be understood that both the foregoing general description and the following detailed description are by examples and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram illustrating a travel plan apparatus according to one embodiment of the present invention;

FIG. 2 is a flowchart illustrating a travel plan method according to one embodiment of the present invention;

FIG. 3 is a flowchart illustrating a method for determining at least one hotel according to one embodiment of the present invention;

FIG. 4a is a schematic diagram illustrating group distribution according to one embodiment of the present invention;

FIG. 4b is a schematic diagram illustrating group distribution according to another embodiment of the present invention;

FIG. 5 is a flowchart illustrating a method for distributing the tourist attraction to the group according to one embodiment of the present invention; and

FIG. 6 is a flowchart illustrating a travel plan method according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

Although the terms “first,” “second,” etc., may be used herein to describe various elements, these elements should not be limited by these terms. These terms are used to distinguish one element from another.

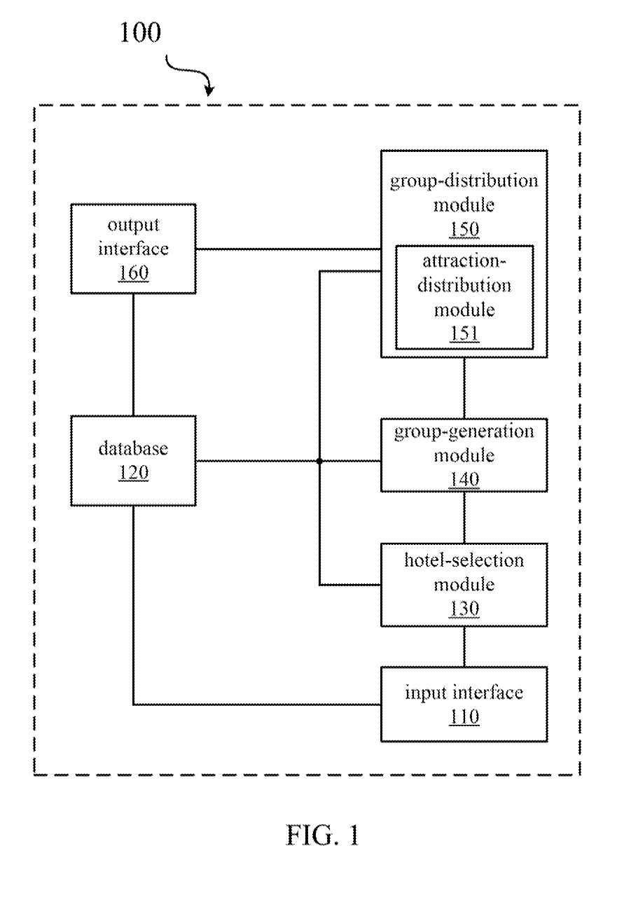

Referring to FIG. 1, FIG. 1 is a block diagram illustrating a travel plan apparatus 100 according to one embodiment of the present invention. The travel plan apparatus 100 includes an input interface 110, a database 120, a hotel-selection module 130, a group-generation module 140, group-distribution module 150, and an output interface 160. In one embodiment, the input interface 110 and the output interface 160 can include a screen of a computer or a screen of a portable electronic device (e.g., a screen of a mobile phone), etc. A user can use a mouse or touch through the input interface 110 for inputting corresponding operation instructions. The plan apparatus 100 can generates the computing results according to the corresponding operation instructions and displays the computing results through the output interface 160 to the user, but the present invention is not limited thereto. Moreover, data of several hotels and several tourist attractions can be established in the database 120 previously. The data can include open time of the tourist attraction, the room rate of the hotel, and the location between the tourist attraction and the hotel, etc. The hotel-selection module 130, the group-generation module 140, and the group-distribution group can execute the corresponding operations according the aforementioned data.

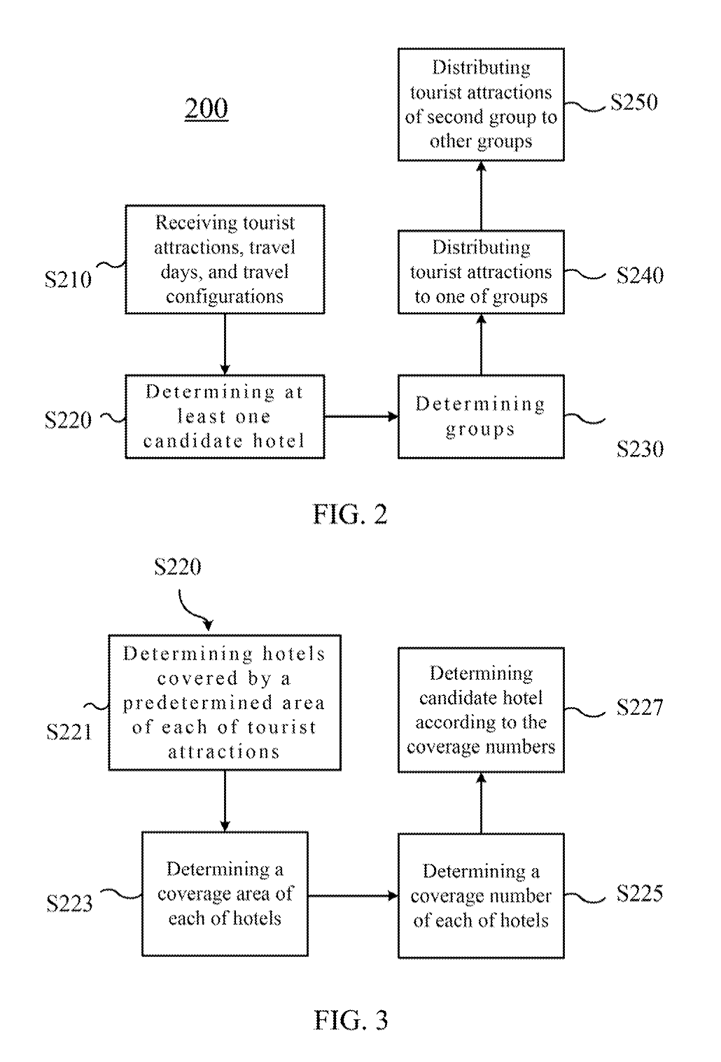

FIG. 2 is a flowchart illustrating a travel plan method 200 according to one embodiment of the present invention. A travel plan method 200 may be a computer program product (e.g., application program) and may be stored at a non-transitory computer readable storage medium so that computer can read the non-transitory computer readable storage medium and execute the performance management method 300. The non-transitory computer readable storage medium includes a read-only memory, flash memory, floppy drive, hard drive, optical disk, thumb disk, magnetic tape, cloud database or equivalents.

Please refer to FIG. 1 and FIG. 2. For illustration purpose, the travel plan apparatus 100 of FIG. 1 and the travel plan method 200 will be explained altogether.

In operation S210, several tourist attractions, several travel days, and several travel configurations inputted from the user are received through the input interface 110. The tourist attractions are spots in which the user would like to travel within the travel days. For example, supposing the travel days are four days, and the tourist attractions are ten spots. The travel plan method 200 is configured for arranging a travel with ten spots in four days.

Furthermore, the travel configurations are selected weights of several factors for the tourist attractions and the hotels according the preference of the user, as shown in Chart 1. Specifically, several hotel configurations of the travel configurations would determine the hotels that the user stays in the travel days. Several attraction configurations and several relation configurations of the travel configurations would determine the spots that the user travels in each of the travel days. The specific descriptions are disclosed on the following embodiments.

CHART 1

| | Factors | Weights |
|---|---|---|
| Hotel | Room rate | 1 |
| Configurations | Distance | 0.8 |
| | Popular time | 0.6 |
| Attraction | Ticket | 1 |
| Configurations | Travel time | 0.8 |
| | Type | 0.6 |
| Relation | Repetition of tourist | 1 |
| Configurations | attraction of group | |
| | Travel time of group | 0.8 |
| | Traffic time between | 0.6 |
| | hotel and tourist | |
| | attraction | |

It is worth to note that the Chart 1 is an exemplary embodiment; in other words, persons of ordinary skill in the art may use various implements, included within the spirit and scope of the appended claims, to realize the result of the aforementioned travel configurations.

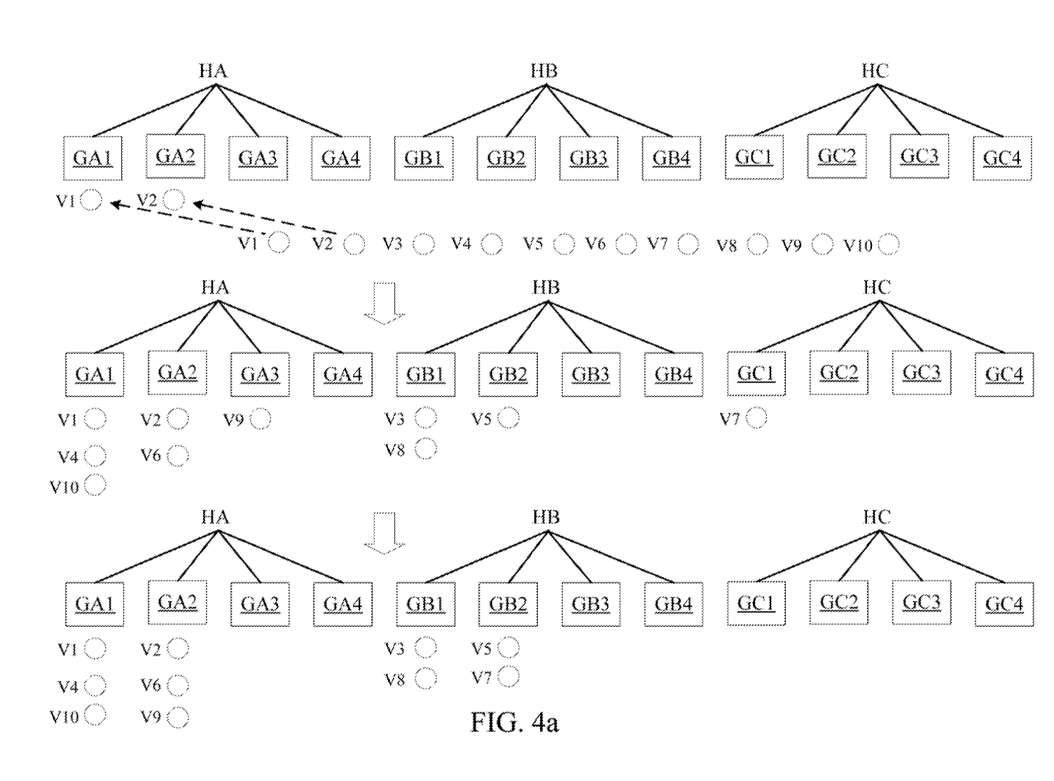

In operation S220, the data of the tourist attractions and the hotels in the database 120 are analyzed through the hotel-selection module 130 according to the factor weights of the hotel configurations of the travel configurations, as a result that at least one candidate hotel is determined. Specifically, operation S220 for determining at least one candidate hotel can further include operation S221 to operation S227. Referring to FIG. 3, FIG. 3 is a flowchart illustrating a method for determining at least one hotel according to one embodiment of the present invention. In operation S221, several hotels covered by a predetermined area for each of the tourist attractions are determined through the hotel-selection module 130. For example, the hotel-selection module 130 can determine the hotels covered by a circle area, in which the center of the circle area is the tourist attraction, and the radius of the circle area is ten kilometers.

In operation S223, a coverage area of each of the hotels is determined through the hotel-selection module 130 according to the factor weights of the hotel configurations. The coverage area of each of the hotels is different. Furthermore, in operation S225, a coverage number of covered tourist attractions for each of the hotels is determined by the hotel-selection module 130 according to the coverage area of the corresponding hotel. In other words, the coverage number of each of the hotels is that the coverage area of the corresponding hotel covers at least one of the tourist attractions (since the hotel is determined base on the tourist attraction within the predetermined area). Moreover, since the coverage area of each of the hotels is different, the coverage number of each of the hotels is different, too.

In operation S227, at least one candidate hotel is determined through the hotel-selection module 130 according to the coverage numbers. In one embodiment, the hotel-selection module 130 determines that one of the at least one candidate hotels is a hotel with the highest coverage number within a predetermined zone.

Accordingly, through the operation S221 to operation S227, the hotel-selection module 130 may determine several hotels as the candidate hotels according to different predetermined zones. It is worth to note that the quantity of the candidate hotels is smaller than the quantity of the travel days; in other words, the quantity of the candidate hotels is smaller than or equal to the quantity of the travel days minus one.

Moreover, if the coverage number of a first hotel of the hotels is substantially equal to the coverage number of a second hotel of the hotels in the same predetermined zone, the hotel-selection module 130 can further provide the first hotel and the second hotel to the user for determining one of the first hotel and the second hotel as one of the candidate hotel in the said predetermined zone.

Referring to FIG. 2, after at least one candidate hospital is determined, several groups are determined through the group-generating module 140 according to the candidate hotels and travel days in operation 5230. Specifically, the quantity of the groups is the product of the quantity of the candidate hotels and the quantity of the travel days. In other words, each of the candidate hotels includes the groups corresponding to the travel days. For example, supposing the quantity of the candidate hotels is three, and the travel days are four days. As a result, the quantity of the groups is twelve. Each of the candidate hotels includes four groups.

Furthermore, in operation S240, each of the tourist attractions is distributed to a corresponding one of the groups through the group-distribution module 150 by using a relation-clustering method. For example, the group-distribution module 150 can distribute each of ten tourist attractions to the corresponding one of twelve groups by using the relation-clustering method.

The relation-clustering method is configured for determining several relation values of each of the groups corresponding to each of the tourist attractions according to the factor weights of the relation configurations of the travel configurations. Each of the tourist attractions includes the relation values corresponding to the quantity of the groups. Moreover, the relation-clustering method is configured for distributing each of the tourist attractions to the corresponding one of the groups. The corresponding one of the groups is the group with the largest relation value among the groups corresponding to one tourist attraction.

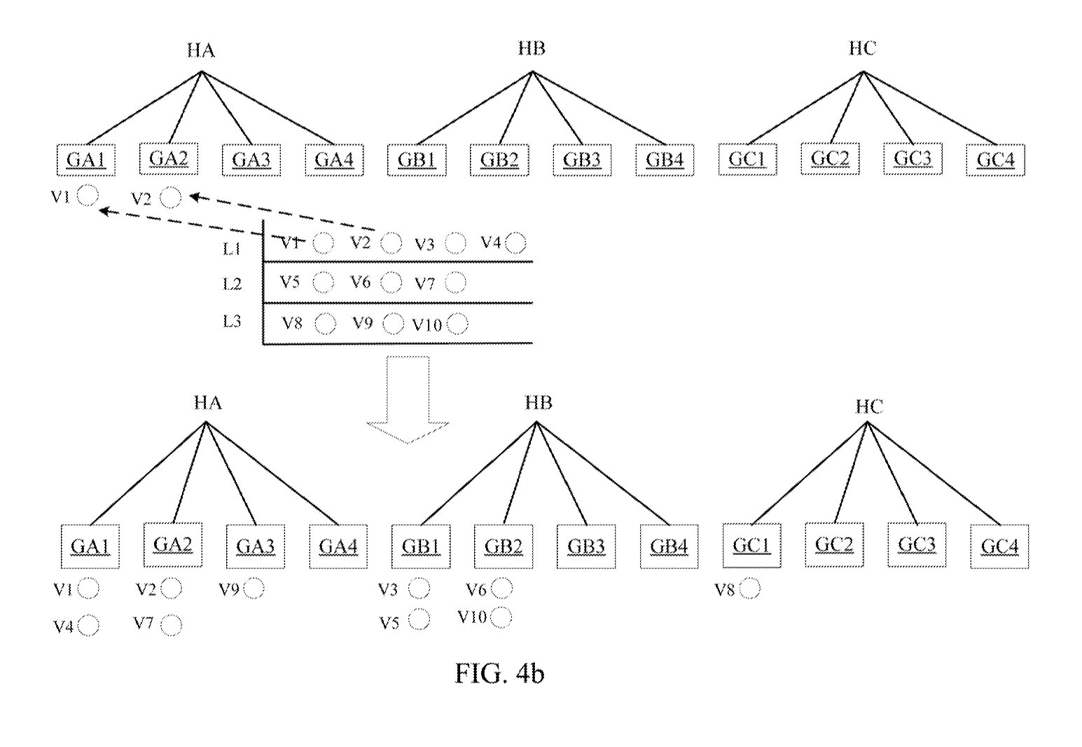

Referring to Chart 2 and FIG. 4a, Chart 2 is a schematic chart illustrating the relation configurations according to one embodiment of the present invention, and FIG. 4a is a schematic diagram illustrating group distribution according to one embodiment of the present invention. In one embodiment, the relation value of one of the groups corresponding to each of the tourist attractions can be obtained by a relation-clustering formula (1), the relation-clustering formula (1) is described as below:

RV(relation value)=W1*A1+W2*A2+W3*A3+W4*A4+W5*A5 (1)

CHART 2

| | Factors | Weights |
|---|---|---|
| Relation | Repetition of tourist attraction | W1 |
| Configurations | of group (A1) | |
| | Traffic time on attraction of | W2 |
| | group (A2) | |
| | Arranged travel time of group | W3 |
| | (A3) | |
| | Overlapping of open time for | W4 |
| | attraction of group (A4) | |
| | Similarity of open date for | W5 |
| | attraction of group (A5) | |

It is worth to note that the Chart 2 is an exemplary embodiment; in other words, persons of ordinary skill in the art may use various implements, included within the spirit and scope of the appended claims, to realize the result of the aforementioned relation configurations.

For example, as shown in FIG. 4a, there are ten tourist attractions V1˜V10 are arranging in four travel days, and there are three candidate hotels HA, HB, and HC. The candidate hotel HA includes the groups GA1 GA2, GA3, and GA4. The candidate hotel HB includes the groups GB1, GB2, GB3, and GB4. The candidate hotel HC includes the groups GC1, GC2, GC3, and GC4. The candidate hotels and the groups can be determined by the aforementioned operations, thus they are not further detailed herein.

Furthermore, each of the tourist attractions is distributed to one of the groups GA1˜GC4. For the tourist attraction V1, twelve relation values of the groups GA1˜GC4 corresponding to the tourist attraction V1 can be obtained by the relation-clustering formula (1). Then, the tourist attraction V1 is distributed to the group with the largest relation value (e.g., the group GA1) among the groups GA1˜GC4. Since the group GA1 includes the tourist attraction V1, the factor A3 (the arranged travel time of the group) of the relation configurations in Chart 2 is changed. Therefore, the relation value of the group GA1 corresponding to the next tourist attraction (e.g., the tourist attraction V2) obtained by the relation-clustering formula (1) would change. As a result, the relation values of other groups GA2˜GC4 corresponding to the tourist attraction V2 may be higher than the relation value of the group GA1 corresponding to the tourist attraction V2, and the tourist attraction V2 would be distributed to the other group with the highest relation value (e.g., the group GA2) among the groups GA2˜GC4. Then, the aforementioned operations are executed repeatedly until the distributions of the tourist attractions V1˜V10 are completed.

In one embodiment, the group-distribution module 150 can further include an attraction-distribution module 151. The attraction-distribution module 151 is configured for distributing the tourist attractions into several levels according to several tourist attraction configurations of the travel configurations. Each of the levels includes a different threshold value. Moreover, operation S240 for distributing each of the tourist attractions to the corresponding one of the groups can further include operation S241 to operation S247.

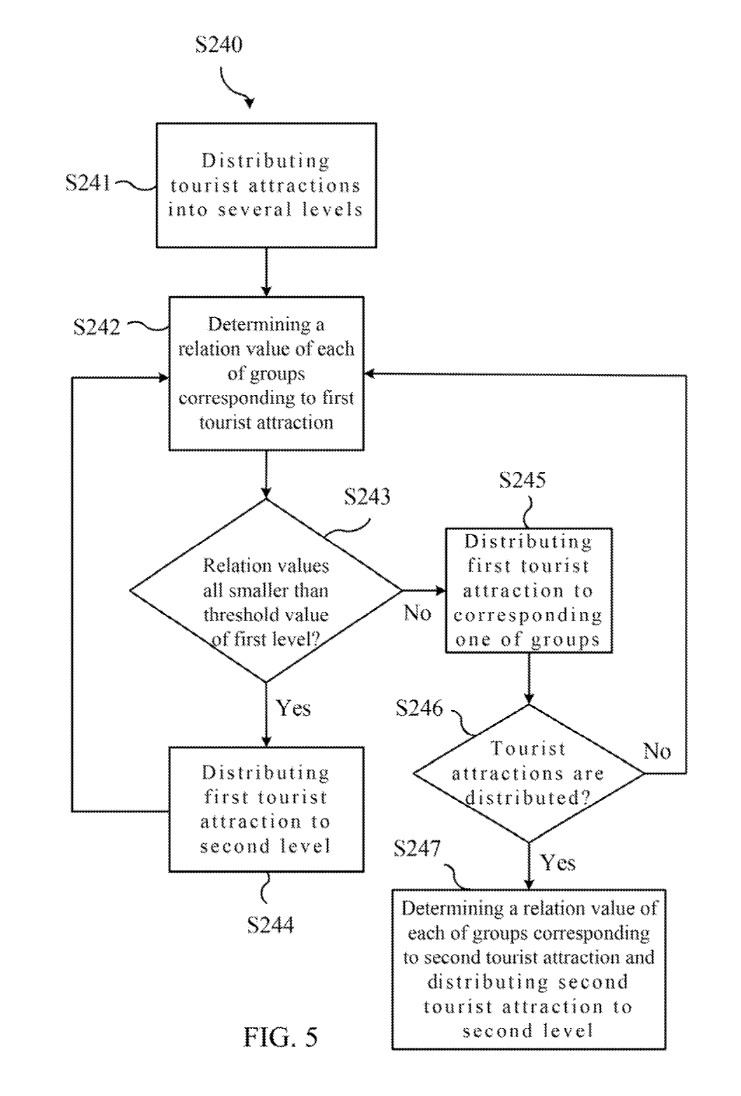

Referring to FIG. 4b and FIG. 5, FIG. 4b is a schematic diagram illustrating group distribution according to another embodiment of the present invention, and FIG. 5 is a flowchart illustrating a method for distributing the tourist attraction to the group according to one embodiment of the present invention. In operation S241 the tourist attractions are distributed into several levels through the attraction-distributing module 151 according to the attraction configurations of the travel configurations. Each of the levels includes the different threshold value. As shown in FIG. 4b, the tourist attractions V1˜V10 are distributed into three levels L1, L2, and L3. The threshold value corresponding to the level L1 is larger than the threshold value corresponding to the level L2, and the threshold value corresponding to the level L2 is larger than the threshold value corresponding to the level L3.

In operation S242, according to the order of the thresholds corresponding to the levels, the group-distribution module determines the relation value of each of the groups GA1˜GC4 corresponding to a first tourist attraction (e.g., the tourist attraction V1) among non-distributed tourist attractions (e.g., the tourist attraction V1˜V4) in a first level (e.g., the level L1) of the levels is determined through the group-distribution module 150 by using the relation-clustering method.

In operation S243, when the relation values of all of the groups GA1˜GC4 corresponding to the first tourist attraction are smaller than the threshold value corresponding to the first level, operation S244 is executed, the first tourist attraction is distributed to the second level (e.g., the level L2) through the group-distribution module 150. Then back to operation 8242. The threshold value corresponding to the first level is larger than the threshold value corresponding to the second level. When the relation value of at least one of the groups GA1˜GC4 corresponding to the first tourist attraction (e g., the tourist attraction V1) is larger than the threshold value corresponding to the first level, operation S245 is executed, the first tourist attraction is distributed to the corresponding one of the groups (e g., the group GA1).

Moreover, in operation S246, whether the tourist attractions (e.g., the tourist attractions V1˜V4) in the first level are distributed is determined. When there is at least one non-distributed tourist attraction in first level, back to operation 242. When the tourist attractions in the first level are distributed, operation 247 is executed, the relation value of each of the groups GA1˜GC4 corresponding to a second tourist attraction (e.g., the tourist attraction V5) among non-distributed tourist attractions (e.g., the tourist attraction V5˜V7) in the second level is determined through the group-distribution module 150 by using the relation-clustering method and the second tourist attraction is distributed to the corresponding one of the groups. Then, the aforementioned operations are executed repeatedly until the distributions of the tourist attractions V1˜V10 in three levels L1 L2, and L3 are completed.

Referring to FIG. 2 and FIG. 4a, in operation S250, when the quantity of several first groups (e.g., the groups GA1˜GA3, GB1˜GB2, and GC1) of the groups including at least one of the tourist attractions is larger than the quantity of the travel days, the tourist attractions of a second group of the first groups is distributed to other groups of the first groups by using the relation-clustering method. The second group includes the tourist attractions with the shortest travel time.

Specifically, since all tourist attractions have to be arranged within the travel days, it is necessary to re-distribute the tourist attractions of partial of the first groups including at least one tourist attraction to other groups of the first groups when the quantity of the first groups is larger than the quantity of the travel days.

There are two ways for re-distributing the tourist attractions of partial of the first groups to other groups of the first groups according to two conditions. In the first condition, when the candidate hotel (e.g., the candidate hotel HA) corresponding to the second group (e.g., the group GA3) further includes at least one third group (e.g., the groups GA1 and GA2) of the other groups, each of the tourist attractions (e.g., the tourist attraction V9) of the second group is distributed to one of the at least one third group (e.g., the groups GA1 or GA2) by using the relation-clustering method.

In the second condition, when the candidate hotel (e.g., the candidate hotel HC) corresponding to the second group (e.g., the group GC1) does not include each of the other groups, all the tourist attractions (e.g., the tourist attraction V7) of the second group are distributed to one of the other groups (e.g., the group GA1, GA2, GA3, GB1, or GB2) by using the relation-clustering method.

Accordingly, through the aforementioned operations, there are four groups GA1, GA2. GB1, and GB2 including all tourist attractions V1˜V10. The groups GA1 and GA2 belong to the candidate hotel HA, and the groups GB1 and GB2 belong to the candidate hotel HB. In other words, the tourist attractions V1˜V10 can be arranged within four travel days through the travel plan method 200, and some tourist attractions are arranged around the candidate hotel HA in two of four travel days while other tourist attractions are arranged around the candidate hotel HB in other two of four travel days.

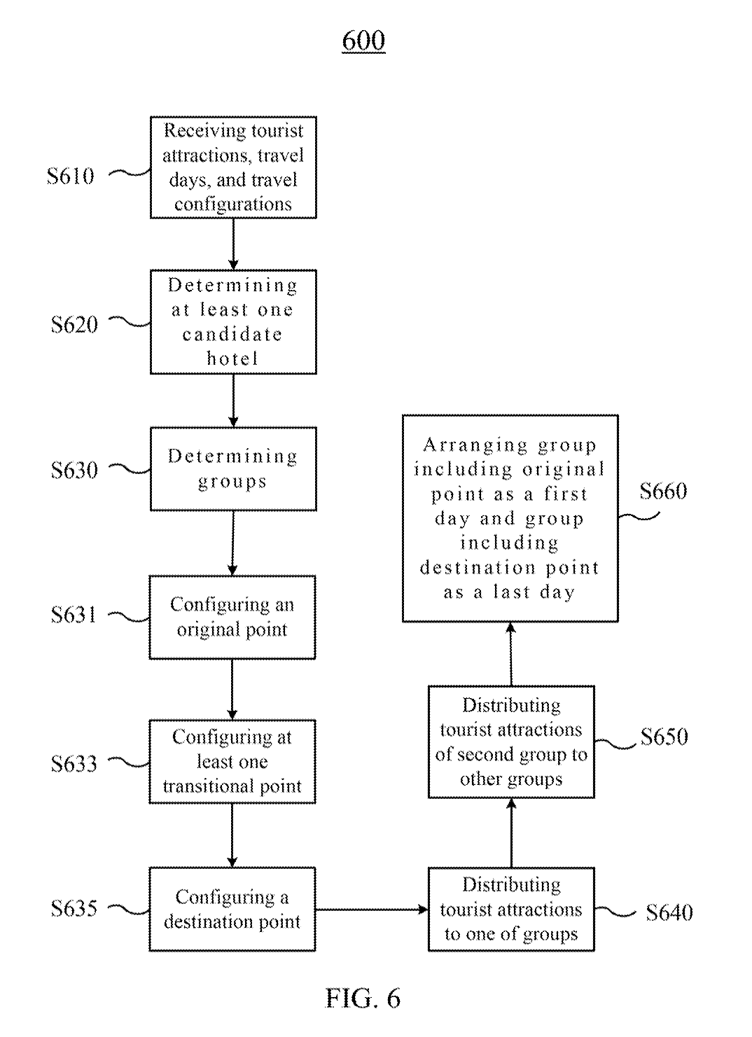

Referring to FIG. 6, FIG. 6 is a flowchart illustrating a travel plan method according to another embodiment of the present invention. In the present embodiment, the travel plan method 600 is further configured for arranging one of the travel days to proceed the selected tourist attractions and stay in the selected hotel.

In the present embodiment, operation S610 to operation 650 are similar to those in the aforementioned embodiments, and thus they are not further detailed herein. In operation S631, an original point is configured. The original point belongs to a fourth group of the groups. In one embodiment, the fourth group includes the minimum traffic time between the candidate hotel corresponding to the fourth hotel and the original point, but the present embodiment is not limited thereto.

In operation 3633, at least one transitional point is configured. Each of at least one transitional point belongs to a fifth group of the groups. In operation S635, a destination point is configured. The destination point belongs to a sixth group of the groups. It is worth to note that the candidate hotel corresponding to the fifth group and the candidate hotel corresponding to the sixth group are different from the candidate hotel corresponding to the fourth group.

After the original point, at least one transitional point, and the destination point are configured, operation S640 to operation S650 are executed, in which operation S610 to operation 650 are similar to those in the aforementioned embodiments, and thus they are not further detailed herein. When all tourist attractions are distributed and the quantity of the first groups is equal to the quantity of the travel days, operation 3660 is executed, the tourist attractions of the fourth group are arranged as a first day of a travel schedule and the tourist attractions of the sixth group are arranged as a last day of the travel schedule.

It is worth to note that the user can arrange the tourist attractions and the hotel of each of the travel days through the disclosed travel plan method. Furthermore, the user can further execute corresponding algorithm (e.g., Google Map API, Exhaustive method, etc) on the selected tourist attractions of each of the travel days to arrange the shortest path among the selected tourist attractions, but they are not limiting of the present invention.

As mentioned above, the travel plan apparatus 100 or the travel plan method 200/600 may be implemented in terms of software, hardware and/or firmware. For instance, if the execution speed and accuracy have priority, then the travel plan apparatus 100 may be implemented in terms of hardware and/or firmware. For illustration, if speed and accuracy are determined to be paramount, a hardware and/or firmware implementation is mainly selected and utilized. Alternatively, if flexibility is paramount, a software implementation is mainly selected and utilized. Furthermore, the travel plan apparatus 100 may be implemented in terms of software, hardware and firmware in the same time. It is noted that the foregoing examples or alternates should be treated equally, and the present invention is not limited to these examples or alternates. Anyone who is skilled in the prior art can make modification to these examples or alternates in flexible way if necessary.

As illustrated from the aforementioned embodiments of the present invention, through the travel plan method, at least one candidate hotel and several groups are determined and each of the tourist attractions is distributed to the corresponding one of the groups by using the relation-clustering method. Moreover, the tourist attractions are re-distributed when the quantity of the groups including at least one tourist attraction is larger than the quantity of the travel days. Whereby all tourist attractions of the travel schedule can be arranged automatically within the configured travel days, and the user do not have to stay in the same hotel in each of the travel days. In other words, the travel arrangement becomes more flexible and convenient, and it save more traffic time in the travel.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A travel plan method, comprising:
providing a plurality of tourist attractions, a plurality of travel days, and a plurality of travel configurations;
determining at least one candidate hotel according to a plurality of hotel configurations of the travel configurations;
determining a plurality of groups according to the at least one candidate hotel and the travel days, wherein each of the at least one candidate hotel comprises the groups corresponding to the travel days;
distributing each of the tourist attractions to a corresponding one of the groups by using a relation-clustering method; and
when the quantity of a plurality of first groups of the groups comprising at least one of the tourist attractions is larger than the quantity of the travel days, distributing the tourist attractions of a second group of the first groups to other groups of the first groups, wherein the second group comprising the tourist attractions with the shortest travel time.

2. The travel plan method as claimed in claim 1, wherein distributing the tourist attractions of the second group of the first groups to the other groups of the first groups comprises:
when a candidate hotel corresponding to the second group further comprises at least one third group of the other groups, distributing each of the tourist attractions of the second group to one of the at least one third group by using the relation-clustering method.

3. The travel plan method as claimed in claim 2, wherein distributing the tourist attractions of the second group of the first groups to the other groups of the first groups comprises:
when the candidate hotel corresponding to the second group does not comprise each of the other groups, distributing all the tourist attractions of the second group to one of the other groups by using the relation-clustering method.

4. The travel plan method as claimed in claim 1, wherein distributing the each of the tourist attractions to the corresponding one of the groups by using the relation-clustering method further comprises:
distributing the tourist attractions into a plurality of levels according to a plurality of tourist attraction configurations of the travel configurations, wherein the levels are corresponding to different threshold values;
according to the order of the threshold values corresponding to the levels, determining a relation value of each of the groups corresponding to a first tourist attraction by using the relation-clustering method, wherein the first tourist attraction is among non-distributed tourist attractions in a first level of the levels;
distributing the first tourist attraction to the corresponding one of the groups;
when the tourist attractions in the first level are distributed, determining the relation value of each of the groups corresponding to a second tourist attraction by using the relation-clustering method, wherein the second tourist attraction is among non-distributed tourist attractions in a second level of the levels; and
distributing the second tourist attraction to the corresponding one of the groups;
wherein the threshold value corresponding to the first level is larger than the threshold value corresponding to the second level.

5. The travel plan method as claimed in claim 4, wherein according to the order of the threshold values corresponding to the levels, determining the to relation value of the each of the groups corresponding to the first tourist attraction by using the relation-clustering method further comprises:
when the relation values of all of the groups corresponding to the first tourist attraction are smaller than the threshold value corresponding to the first level, distributing the first tourist attraction to the second level.

6. The travel plan method as claimed in claim 1, wherein the relation-clustering method comprises:
determining a plurality of relation values of each of the groups corresponding to each of the tourist attractions, wherein the each of the tourist attractions comprises the relation values corresponding to the quantity of the groups; and
distributing the each of the tourist attractions to the corresponding one of the groups, wherein the corresponding one of the groups comprises the largest relation value among the relation values corresponding to the quantity of the groups.

7. The travel plan method as claimed in claim 1, wherein before distributing the each of the tourist attractions to the corresponding one of the groups by using the relation-clustering method further comprises:
configuring an original point, wherein the original point belongs to a fourth group of the groups;
configuring at least one transitional point, wherein each of the at least one transitional point belongs to at least one fifth group of the groups; and
configuring a destination point, wherein the destination point belongs to a sixth group of the groups;
wherein the candidate hotel corresponding to the at least one fifth group and the candidate hotel corresponding to the sixth group are different from the candidate hotel corresponding to the fourth group.

8. The travel plan method as claimed in claim 7, further comprising:
when the quantity of the first groups is equal to the quantity of the travel days, arranging the tourist attractions of the fourth group as a first day of a travel schedule, and arranging the tourist attractions of the sixth group as a last day of the travel schedule.

9. The travel plan method as claimed in claim 1, wherein determining the at least one candidate hotel according to the hotel configurations of the travel configurations comprises:
determining a plurality of hotels covered by a predetermined area for each of the tourist attractions;
determining a coverage area of each of the hotels according to the hotel configurations;
determining a coverage number of covered tourist attractions for the each of the hotels according to the coverage area of the each of the hotels; and
determining the at least one candidate hotel according to the coverage number of the each of the hotels, wherein the quantity of the at least one hotel is smaller than or equal to the quantity of the travel days minus one.

10. The travel plan method as claimed in claim 9, further comprising:
when the coverage number of a first hotel of the hotels is substantially equal to the coverage number of a second hotel of the hotels, providing the first hotel and the second hotel to an user for determining one of the first hotel and the second hotel as one of the at least one candidate hotels.

11. An travel plan apparatus, comprising:
an input interface, configured for receiving a plurality of tourist attractions, a plurality of travel days, and a plurality of travel configurations;
a database, configured for providing a plurality of data corresponding to the tourist attractions and a plurality of hotels;
a hotel-selection module, configured for analyzing the data corresponding to the tourist attractions and the hotels in the database according to a plurality of hotel configurations of the travel configurations to determine at least one candidate hotel;
a group-generation module, configured for determining a plurality of groups according to the at least one candidate hotel and the travel days, wherein each of the at least one candidate hotel comprises the groups corresponding to the travel days; and
a group-distribution module, configured for distributing each of the tourist attractions to a corresponding one of the groups by using a relation-clustering method, wherein when the quantity of a plurality of first groups of the groups comprising at least one of the tourist attractions is larger than the quantity of the travel days, the group-distribution module distributes the tourist attractions of a second group of the first groups to other groups of the first groups, wherein the second group comprising the tourist attractions with the shortest travel time.

12. The travel plan apparatus as claimed in claim 11, wherein when a candidate hotel corresponding to the second group further comprises at least one third group of the other groups, the group-distribution module distributes each of the tourist attractions of the second group to one of the at least one third group by using the relation-clustering method; when the candidate hotel corresponding to the second group does not comprise each of the other groups, the group-distribution module distributes all the tourist attractions of the second group to one of the other groups by using the relation-clustering method.

13. The travel plan apparatus as claimed in claim 11, wherein the group-distribution module further comprises:
an attraction-distribution module, configured for distributing the tourist attractions into a plurality of levels according to a plurality of tourist attraction configurations of the travel configurations, wherein the levels are corresponding to different threshold values;
wherein according to the order of the threshold values corresponding to the levels, the group-distribution module determines a relation value of each of the groups corresponding to a first tourist attraction by using the relation-clustering method and distributes the first tourist attraction to the corresponding one of the groups, wherein the first tourist attraction is among non-distributed tourist attractions in a first level of the levels, when the tourist attractions in the first level are distributed, the group-distribution module determines the relation value of each of the groups corresponding to a second tourist attraction by using the relation-clustering method, wherein the second to tourist attraction is among non-distributed tourist attractions in a second level of the levels and distributes the second tourist attraction to the corresponding one of the groups, wherein the threshold value corresponding to the first level is larger than the threshold value corresponding to the second level.

14. The travel plan apparatus as claimed in claim 13, wherein when the relation values of all of the groups corresponding to the first tourist attraction are smaller than the threshold value corresponding to the first level, the group-distribution module distributes the first tourist attraction to the second level.

15. The travel plan apparatus as claimed in claim 11, wherein the relation-clustering method comprises:
determining a plurality of relation values of each of the groups corresponding to each of the tourist attractions, wherein the each of the tourist attractions comprises the relation values corresponding to the quantity of the groups; and
distributing the each of the tourist attractions to the corresponding one of the groups, wherein the corresponding one of the groups comprises the largest relation value among the relation values corresponding to the quantity of the groups.

16. A storage media for storing a travel plan program, wherein the travel plan program comprises a plurality of program codes to be loaded onto a computer system so that a travel plan method is executed by the computer system, and the travel plan method comprises:
providing a plurality of tourist attractions, a plurality of travel days, and a plurality of travel configurations;
determining at least one candidate hotel according to a plurality of hotel configurations of the travel configurations;
determining a plurality of groups according to the at least one candidate hotel and the travel days, wherein each of the at least one candidate hotel comprises the groups corresponding to the travel days;
distributing each of the tourist attractions to a corresponding one of the groups by using a relation-clustering method; and
when the quantity of a plurality of first groups of the groups comprising at least one of the tourist attractions is larger than the quantity of the travel days, distributing the tourist attractions of a second group of the first groups to other groups of the first groups, wherein the second group comprising the tourist attractions with the shortest travel time.

17. The storage media as claimed in claim 16, wherein the travel plan method comprises:
when a candidate hotel corresponding to the second group further comprises at least one third group of the other groups, distributing each of the tourist attractions of the second group to one of the at least one third group by using the relation-clustering method; and
when the candidate hotel corresponding to the second group does not comprise each of the other groups, distributing all the tourist attractions of the to second group to one of the other groups by using the relation-clustering method.

18. The storage media as claimed in claim 16, wherein the travel plan method further comprises:
distributing the tourist attractions into a plurality of levels according to a plurality of tourist attraction configurations of the travel configurations, wherein the levels are corresponding to different threshold values;
according to the order of the threshold values corresponding to the levels, determining a relation value of each of the groups corresponding to a first tourist attraction by using the relation-clustering method, wherein the first tourist attraction is among non-distributed tourist attractions in a first level of the levels;
distributing the first tourist attraction to the corresponding one of the groups;
when the tourist attractions in the first level are distributed, determining the relation value of each of the groups corresponding to a second tourist attraction by using the relation-clustering method, wherein the second tourist attraction is among non-distributed tourist attractions in a second level of the levels; and
distributing the second tourist attraction to the corresponding one of the groups;
wherein the threshold value corresponding to the first level is larger than the threshold value corresponding to the second level.

19. The storage media as claimed in claim 18, wherein the travel plan method further comprises:
when the relation values of all of the groups corresponding to the first tourist attraction are smaller than the threshold value corresponding to the first level, distributing the first tourist attraction to the second level.

20. The storage media as claimed in claim 18, wherein the relation-clustering method comprises:
determining a plurality of relation values of each of the groups corresponding to each of the tourist attractions, wherein the each of the tourist attractions comprises the relation values corresponding to the quantity of the groups; and
distributing the each of the tourist attractions to the corresponding one of the groups, wherein the corresponding one of the groups comprises the largest relation value among the relation values corresponding to the quantity of the groups.
